(19) United States
(12) Patent Application Publication
(10) Pub. No.: US 2003/0178446 A1
(43) Pub. Date: Sep. 25, 2003

(54) Offset caulking nozzle

(76) Inventor: Alan George Osgood, Carnation, WA (US)

Correspondence Address: Alan G. Osgood, 10705 East Lake Joy Dr NE, Carnation, WA, 98014, US

(21) Appl. No.: 10/106,518

(22) Filed: Mar. 25, 2002

(51) Int. Cl. G01F 11/06; G01F 11/30

(52) U.S. Cl. 222/327

(57) ABSTRACT

A caulking cartridge 21 comprising a cylindrical body section 22 for holding caulking or other material, an offset dispensing nozzle 41 on the cartridge body section end wall 12, and a moveable diaphragm 27 for propelling the material towards the offset nozzle 41. The offset nozzle 41 has a base 42 for attaching the offset nozzle 41 to the body section end wall 12, a tubular mid section 44 for conveying the material, and an offset tip 43 containing an offset dispensing orifice 45 for dispensing the material. The nozzle base 42 is attached to the body section end wall 12 at the body section longitudinal centerline 25. The offset nozzle tip 43 and offset dispensing orifice 45 are laterally offset from the body section longitudinal centerline 25. The lateral offset of the nozzle tip 43 and dispensing orifice 45 facilitates applying caulking in difficult to access locations.

### BACKGROUND OF THE INVENTION

1. The Field of the Invention

The present invention relates to nozzles for disposable caulking cartridges.

2. The Prior Art

The term “material’ is used in this specification to refer to any caulking, glue, adhesive, sealant or other substance dispensed from a disposable cartridge through a dispensing nozzle. Caulking cartridge refers to any disposable dispensing container comprising a rigid cylindrical body section for holding material, a rigid dispensing nozzle integral to the end wall of the cylindrical body section, and a movable diaphragm or piston for moving the material towards the nozzle. Movement of the moveable diaphragm towards the nozzle expels the material through a dispensing orifice in the nozzle tip.

Caulking is used to fill or seal cracks, holes and deformities in structures. Standard caulking cartridges have a cylindrical body section of approximately 8″ to 8.5″ in length and approximately 1.75″ to 2″ in diameter. A cylindrical dispensing nozzle typically extends approximately 3″ from the end wall of the cylindrical body section. The dispensing nozzle is symmetrical around the longitudinal centerline of the cartridge body section. The base of the caulking cartridge nozzle is attached to the caulking cartridge body at the center of the body end wall. The nozzle tip is located on the longitudinal centerline of the caulking cartridge cylindrical body section. Larger size caulking cartridges of the same basic configuration are also available.

A device ordinarily called a caulking gun is typically used to dispense material from a caulking cartridge. The caulking cartridge is mounted in the caulking gun. The caulking gun end piece and side members hold the caulking cartridge in place. Manual activation of the caulking gun lever or trigger propels the caulking pusher rod and piston towards the caulking cartridge nozzle. This in turn propels the moveable diaphragm in the caulking cartridge body towards the caulking cartridge nozzle. Material is then expelled through the dispensing orifice in the nozzle tip and applied to the proper location. To apply caulking, the caulking gun is positioned so that the dispensing orifice on the nozzle tip contacts the point where caulking is to be applied. Activation of the caulking gun lever then applies the caulking. It is critical that the orifice on the nozzle tip be positioned precisely in the location where the caulking is to be applied.

The basic configuration of caulking guns has changed little since the 1920s. U.S. Pat. No. 1,536,477 issued to Crewe in 1925 describes a caulking gun similar in configuration to caulking guns in use today. The caulking gun has a tubular or cylindrical body section to hold the caulking, a piston activated by a handle and lever on one end of the body section, and a dispensing tube or nozzle on the other end of the body. U.S. Pat. No. 1,883,767 issued to Crewe in 1932 describes a different ratchet mechanism for activating the piston. U.S. Pat. No. 2,115,591 issued to Sherbondy in 1938 describes a caulking gun designed to be used with disposable caulking cartridges. U.S. Pat. No. 2,340,433 issued to Skinner describes a caulking gun with a cylindrical body comprised of a non-metallic substance. U.S. Pat. No. 2,367,347 issued to Good in 1945 describes yet another ratchet mechanism for activating the piston. U.S. Pat. No. 2,499,610 issued to Sherbondy in 1950 describes a simplified device for holding a caulking cartridge in a caulking gun. U.S. Pat. No. 4,135,644 issued to Pacetti in 1979 describes a caulking gun with built in devices for cutting open the nozzle tip of a disposable caulking cartridge and for puncturing the seal inside the nozzle. All of the described caulking guns have the same basic configuration. Each of these caulking guns have a tubular or cylindrical body section to hold the caulking and a piston activated by a handle and lever on one end of the body section. Caulking is dispensed though a tube or nozzle on the other end of the body. The nozzle, where one is described, is symmetrical around the longitudinal centerline of the tubular body section.

The basic configuration of disposable cartridges for dispensing caulking and other materials has also changed little since the 1920s. U.S. Pat. No. 1,474,118 issued to Rice in 1923 describes a tubular carton or cartridge for holding and dispensing grease. The closure at one end of the carton constituted in part a nozzle for dispensing the grease. The closure at the other end of the carton constituted a moveable diaphragm for expelling the grease through the nozzle. The nozzle, as described, is symmetrical around the longitudinal centerline of the tubular carton. U.S. Pat. No. 2,111,582 issued to Crewe in 1938 describes another cylindrical cartridge for holding and dispensing caulking. The cartridge is designed to be used in a caulking gun similar to the one described in U.S. Pat. No. 1,536,477, issued to Crewe in 1925. U.S. Pat. No. 2,106,577 issued to Sherbondy in 1938 describes a cartridge for caulking or other material with a different design for sealing the cartridge during shipping and handling. U.S. Pat. No. 2,512,178 also issued to Sherbondy in 1950 describes a caulking cartridge with a different spout or nozzle design than the U.S. Pat. No. 2,106,577 design. U.S. Pat. No. 2,646,906, issued to Jones et al. in 1953 describes a caulking cartridge with still a different nozzle design. U.S. Pat. No. 3,953,957, issued to Brothers et al. in 1976 described a method of applying a protective cap to the nozzle of a caulking cartridge while simultaneously rolling a bead on the piston end of the cartridge. U.S. Pat. No. 4,022,355 issued to Sabaka in 1977 describes a caulking cartridge with a compressible diaphragm. U.S. Pat. No. 4,106,963, issued to Yealy et al. in 1978 describes a method of using heat to join together the pieces of plastic caulking cartridges. All of the described cartridges have the same basic configuration. A cylindrical body section holds the material. The nozzle for dispensing the material is a single piece of relatively rigid material that is integral to the end wall of the cartridge. The nozzle is symmetrical around the longitudinal centerline of the cylindrical body. A moveable diaphragm expels the material towards the nozzle end. All known caulking cartridges in current production are of this same basic configuration.

Proper application of caulking often requires both that the caulking be applied to the correct location, and that caulking be tamped or pressed into seams, joins, crevices and cracks. This requires pressure to be applied by the cartridge tip against the point where the caulking is being applied. Frequently access is limited to the location where the caulking needs to be applied. Often caulking must be applied in a location such as on the backside of a kitchen sink or the backside of a bathtub where a wall or other structure obstructs access to the caulking location. The locations where caulking can be easily applied are limited by the geometric configuration of caulking guns and caulking cartridges. In particular, the position of the nozzle tip on the vertical centerline of the cylindrical body section limits application of caulk, glue, sealant or other types of material in restricted locations. The overall length of the caulking gun, including the pusher rod varies depending on how far the pusher rod extends into the cartridge. When the caulking cartridge is full, the overall length of the caulking gun is over 22″. Frequently it is difficult to apply adequate pressure against the nozzle tip in restricted locations. It is often difficult to position a caulking gun so that the tip of the cartridge nozzle contacts the application point at the correct angle. Sometimes it is not even possible to locate the nozzle tip of a caulking cartridge mounted in a caulking gun in the correct position and angle.

The amount of material that must be applied by a caulking gun varies by job. For some jobs such as caulking around sinks, small strips or beads of material are required. Normally larger beads of material are used to glue large pieces of wood together. For other jobs such as filling large cracks or irregular surfaces even larger beads of material are required. Standard disposable caulking cartridges have a tapered tip. The tip is cut off close to the end to create a small dispensing hole for a small bead of material. More of the tip is cut off to create larger holes for larger beads of material.

One approach to applying caulking in restricted locations is to modify the design of the caulking gun. U.S. Pat. No. 5,875,920 issued to Parent in 1999 describes a caulking gun and caulking cartridges of reduced length. The device is intended to fit into tight spaces such as cupboards, closets, behind doors etc. The reduced length caulking gun will not accept standard length caulking cartridges. The reduced length caulking gun is of limited use in accessing really restricted locations such as on the backside of a sink.

A second approach to applying caulking in difficult locations is to redesign the nozzle tip. The prior art includes several such nozzle tips. U.S. Pat. No. 3,627,435 issued to Hendershot in 1971 describes a caulking nozzle tip with four beveled sides. U.S. Pat. No. 4,101,077 issued to Gibson in 1978 describes a spout or nozzle with the orifice on the side of the tip of the nozzle. U.S. Pat. No. Des. 251,953 issued to VanHorne in 1979 describes another caulking nozzle tip with four beveled sides. U.S. Pat. No. 4,380,425 issued to Edelman in 1989 describes a caulking nozzle with a finger shaped tip. The finger shaped tip is designed to facilitate pressing caulking into seams and joints. U.S. Pat. No. 4,878,599 issued to Greenway in 1989 describes a caulking nozzle with a series of steps of successively smaller diameters. U.S. Pat. No. 5,249,876 issued to Hattman in 1993 describes a caulking nozzle tip that is beveled on three sides. U.S. Pat. No. 5,775,551 issued to Tordsen in 1998 describes a caulking nozzle tip that has two orthogonal planar sidewalls. The devices described in U.S. Pat. Nos. 3,627,435, 4,101,077, Des. 251,953, 4,380,425, 4,878,599, 5,249,876, and 5,775,551 only facilitate application of caulking in locations where the caulking gun can be positioned so that the tip of the nozzle is in the correct angle against the point where caulking is to be applied. These devices do not improve accessibility to restricted locations such as the backside of a sink.

A third approach to applying caulking in difficult locations is to provide a flexible or curved nozzle extension. U.S. Pat. No. 5,029,738 issued to Dillon in 1991 describes a bellowed flexible nozzle to facilitate applying caulking in restricted locations. The nozzle described in U.S. Pat. No. 5,029,738 contains a matrix of shape retaining stiffening wires. If the stiffening wires are conformable enough to be easily bent for accessing difficult to reach locations, they will tend to flex when pressure is applied on the caulking tip. The complex composition of the nozzle increases the manufacturing cost of the nozzle extension.

U.S. Pat. No. 5,249,716 issued to O'Sullivan in 1993 describes another flexible caulking nozzle. A separate rigid curved tube that fits over the flexible nozzle is used to hold the nozzle in a curved position. The combined cost of the flexible nozzle and the curved section increases the manufacturing cost for the nozzle extension.

U.S. Pat. No. 5,346,380 issued to Ables in 1994 describes another flexible nozzle extension. Caulking gun operators press on a spoon device to maintain the position of the nozzle tip. U.S. Pat. No. 5,833,099 issued to Boaz et al. in 1998 describes a long flexible nozzle extension. U.S. Pat. No. 6,076,712 issued to Esber et al. in 2000 describes yet another flexible nozzle extension.

The flexible nozzles described in U.S. Pat. Nos. 5,346,380, 5,833,099, and 6,076,712 have a similar disadvantage. It is difficult to apply enough pressure against the tip of a flexible nozzle or nozzle extension in order to force caulking into seams, joints, crevices or cracks. A caulking gun operator must use one hand to hold the flexible tip tightly against the surface where caulking is being applied and guide it along the application area while using the other hand to activate the caulking gun lever. This is fatiguing at best. At worst an operator can not properly position his or her hand in the restricted area to guide the flexible tip.

What is lacking in the prior art is a nozzle for disposable caulking cartridges that (a) facilitates access to restricted locations, (b) allows one-handed application of caulking under pressure into seams, joints, crevices or cracks, and (c) provides for variable caulking bead size. The present invention satisfies all three of these requirements.

### BRIEF SUMMARY OF THE MENTION

The caulking cartridge of the present invention comprises a cylindrical body section for holding caulking or other material, an offset dispensing nozzle on one end of the body section, and a moveable diaphragm for propelling the material towards the nozzle. The offset nozzle has a base for attaching the nozzle to the body section end wall, a tubular section for conveying the material, and an offset tip containing an offset dispensing orifice for dispensing the material. The nozzle base is attached to the body section end wall at the body section longitudinal centerline. The offset nozzle tip and offset dispensing orifice are laterally offset from the body section longitudinal centerline. The lateral offset of the nozzle tip and dispensing orifice facilitates applying caulking in difficult to access locations.

### BRIEF DESCRIPTION OF THE SEVERAL VIEWS OF THE DRAWINGS

FIG. 1—Prior art side view of caulking cartridge mounted in caulking gun

FIG. 2—Prior art side view of caulking cartridge nozzle

FIG. 3—Prior art end view of caulking cartridge mounted in caulking gun

FIG. 4—Side view of basic slanted offset nozzle

FIG. 5—End view of basic slanted offset nozzle

FIG. 6—End view of basic slanted offset nozzle with offset towards top of caulking gun

FIG. 7—End view of basic slanted offset nozzle with offset towards side of caulking gun

FIG. 8—Side view of caulking cartridge with basic slanted offset nozzle mounted in caulking gun

FIG. 9—Side view of extended slanted offset nozzle

FIG. 10—End view of extended slanted offset nozzle

FIG. 11—Side view of basic curved offset nozzle

FIG. 12—End view of basic curved offset nozzle

FIG. 13—Side view of extended curved offset nozzle

FIG. 14—End view of extended curved offset nozzle

FIG. 15—Side view of basic jointed offset nozzle

FIG. 16—End view of basic jointed offset nozzle

FIG. 17—Side view of extended jointed offset nozzle

FIG. 18—End view of extended jointed offset nozzle

### REFERENCE NUMERALS IN FIGURES

11—Caulking gun

12—Caulking gun end wall

13—Caulking gun side member

14—Caulking gun pusher rod

15—Caulking gun handle

16—Caulking gun lever

17—Caulking gun piston

18—Top of caulking gun

21—Cartridge

22—Cartridge cylindrical body section

23—Cartridge cylindrical sidewall

24—Cartridge fixed end wall

25—Cartridge body longitudinal centerline

26—Cartridge body cylindrical outer surface line

27—Cartridge moveable diaphragm

28—Cartridge body radius

31—Prior art nozzle

32—Prior art nozzle base

33—Prior art nozzle tip

34—Prior art nozzle tubular mid section

35—Prior art dispensing orifice

41—Slanted offset nozzle

42—Slanted offset nozzle base

43—Slanted offset nozzle tip

44—Slanted offset nozzle tubular mid section

45—Slanted offset dispensing orifice

51—Curved offset nozzle

52—Curved offset nozzle base

53—Curved offset nozzle tip

54—Curved offset nozzle tubular mid section

55—Curved offset dispensing orifice

61—Jointed offset nozzle

62—Jointed offset nozzle base

63—Jointed offset nozzle tip

64—tubular near section

65—Jointed offset nozzle tubular distant section

66—Joint between tubular near section and tubular distant section

67—Jointed offset dispensing orifice

### DETAILED DESCRIPTION OF THE INVENTION

Reference is now made to the drawings wherein like parts are designated with like numerals throughout.

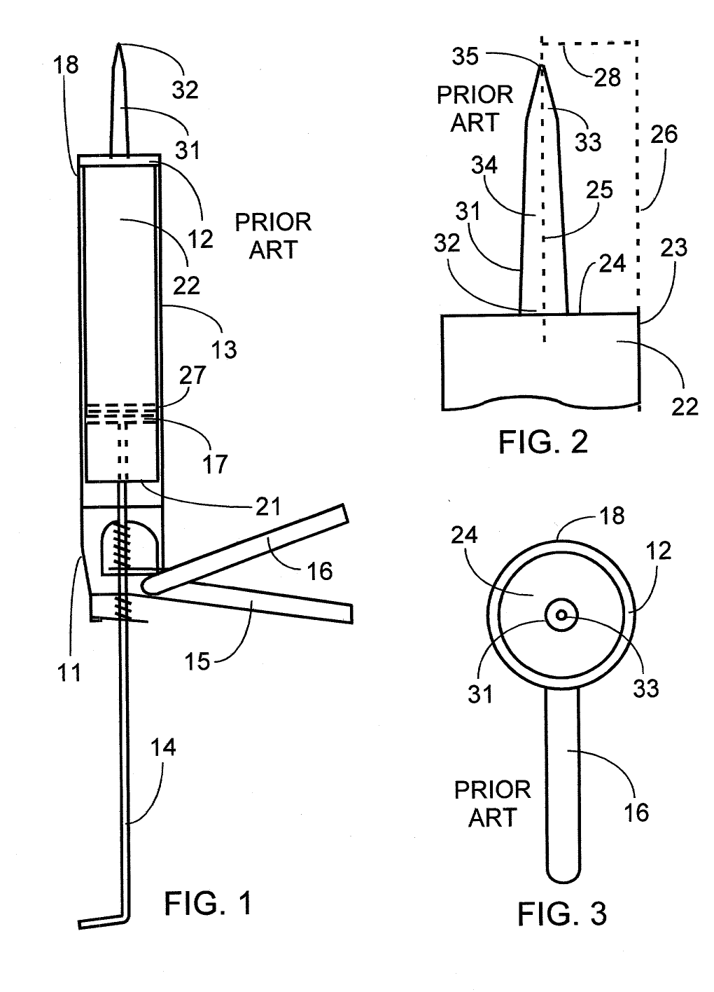

FIG. 1 is a side view of a caulking cartridge 21 mounted in a caulking gun 11. FIG. 2 is a side view of the prior art nozzle 31 attached to the end of a cartridge fixed end wall 24. FIG. 3 is a view from the prior art nozzle tip 33 towards the caulking cartridge fixed end wall 24 when the cartridge 21 is mounted in the caulking gun 11. The caulking gun end piece 12 and side members 13 hold the cartridge 21 in place. The cartridge cylindrical body section 22 holds caulking, adhesive or other material. The cartridge cylindrical sidewall 23, the cartridge fixed end wall 24 and the cartridge moveable diaphragm 27 restrain the material. The cartridge cylindrical body section 22 has a longitudinal centerline 25 and a longitudinal outer surface line 26. The cartridge body longitudinal centerline 25 continues past the fixed end wall 24 of the cartridge body to the tip of the prior art nozzle tip 33. The cartridge body longitudinal outer surface line 26 continues past the fixed end wall 24 of the cartridge body to the tip of the prior art nozzle tip 33. As shown in FIG. 2, the distance from the body longitudinal centerline 25 to the body cylindrical outer surface line 26 is the cartridge body radius 28. The cartridge body radius 28 is constant along the entire cylindrical body section 22 and the prior art nozzle 31. The prior art nozzle 31, which is attached to the cartridge fixed end wall 24, is symmetrical around the cartridge body centerline 25. The prior art nozzle tip 33 and, the prior art nozzle base 32, the prior art nozzle tubular mid section 34, and the prior art nozzle orifice 35 are all on the cartridge body longitudinal centerline 25. The prior art nozzle tip 33 and dispensing orifice 35 are laterally displaced from the caulking gun top 18 by at least the distance of the cartridge body radius 28.

To apply caulking with the prior art nozzle, the caulking gun 11 is positioned so that the prior art dispensing orifice 35 on the prior art nozzle tip 33 contacts the point where caulking is to be applied. Manual movement of the caulking gun level 16 or trigger towards the caulking gun handle 15 propels the caulking pusher rod 14 and piston 17 towards the prior art cartridge nozzle 31. This in turn propels the moveable diaphragm 27 internal to the cartridge cylindrical body section 22 towards the prior art nozzle base 32. Material is propelled through the prior art nozzle tubular mid section 34, expelled through a dispensing orifice 35 in the prior art nozzle tip 33 and applied to the proper location.

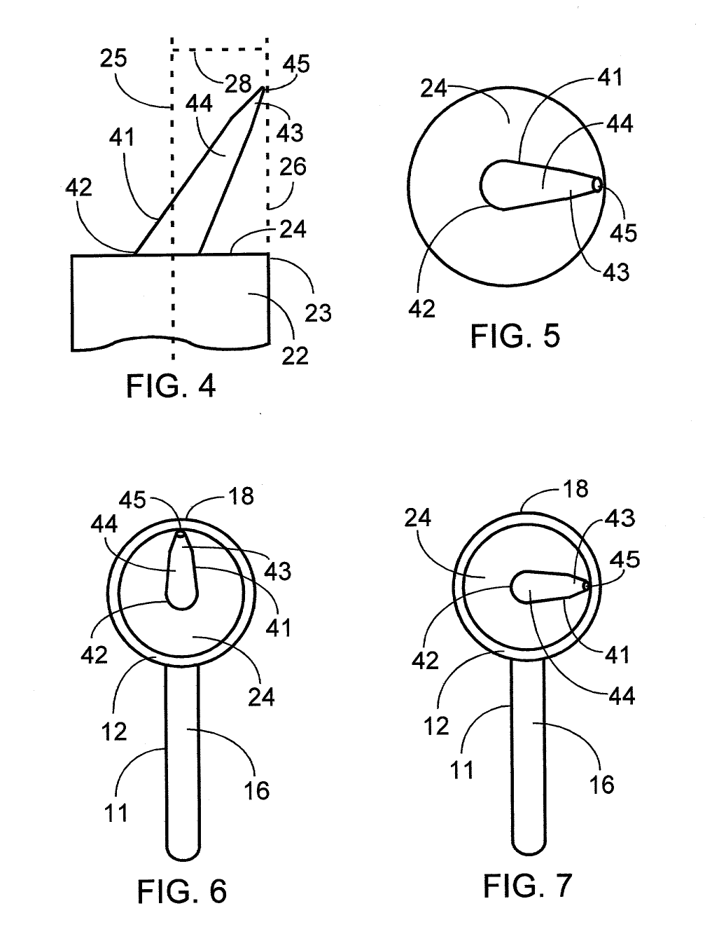

FIGS. 4 and 5 show the basic configuration of the first embodiment of the caulking cartridge nozzle of the present invention hereafter referred to as the basic slanted offset nozzle 41. FIG. 4 is a side view of the basic slanted offset nozzle 41. FIG. 5 is a view towards the cartridge fixed end wall 24. The slanted offset nozzle base 42, which is attached to the cartridge fixed end wall 24, is symmetrical around the cartridge body centerline 25. The cartridge body section is of the same configuration as the in the prior art. The cartridge cylindrical body section 22 has a longitudinal centerline 25 and a longitudinal outer surface line 26. The cartridge body longitudinal centerline 25 continues past the fixed end wall 24 of the cartridge body to the tip of the prior art nozzle tip 33. The cartridge body longitudinal outer surface line 26 continues past the fixed end wall 24 of the cartridge body to the tip of the prior art nozzle tip 33. As shown in FIG. 4, the distance from the body longitudinal centerline 25 to the body cylindrical outer surface line 26 is the cartridge body radius 28. The cartridge body radius 28 is constant along the entire cylindrical body section 22 and the slanted offset nozzle 41. The slanted offset nozzle tubular mid section 44 extends from the slanted offset nozzle base 42 to the slanted offset nozzle tip 43. The slanted offset nozzle tubular mid section 44 diverges at an angle away from the cartridge body longitudinal centerline 25 at the slanted offset nozzle base 42 towards the cartridge body longitudinal outer surface line 26 at the slanted offset nozzle tip 43. The slanted offset nozzle tip 43 and the slanted offset dispensing orifice 45 are offset laterally from the cartridge body longitudinal centerline 25 towards the cartridge body cylindrical outer surface line 26. In the basic configuration of the first embodiment of the present invention, the slanted offset dispensing orifice 45 of the slanted offset nozzle tip 43 is on, or within, the cartridge body cylindrical outer surface line 26.

To apply caulking with the nozzle of the first embodiment of the present invention, the caulking gun 11 is positioned so that the slanted offset dispensing orifice 45 on the slanted offset nozzle tip 43 contacts the point where caulking is to be applied. Manual movement of the caulking gun level 16 or trigger towards the caulking gun handle 15 propels the caulking pusher rod 14 and piston 17 towards the slanted offset cartridge nozzle 41. This in turn propels the moveable diaphragm 27 internal to the cartridge cylindrical body section 22 towards the slanted offset nozzle base 42. Material is propelled through the slanted offset nozzle tubular mid section 44, expelled through the slanted offset dispensing orifice 45 in the slanted offset nozzle tip 43 and applied to the proper location.

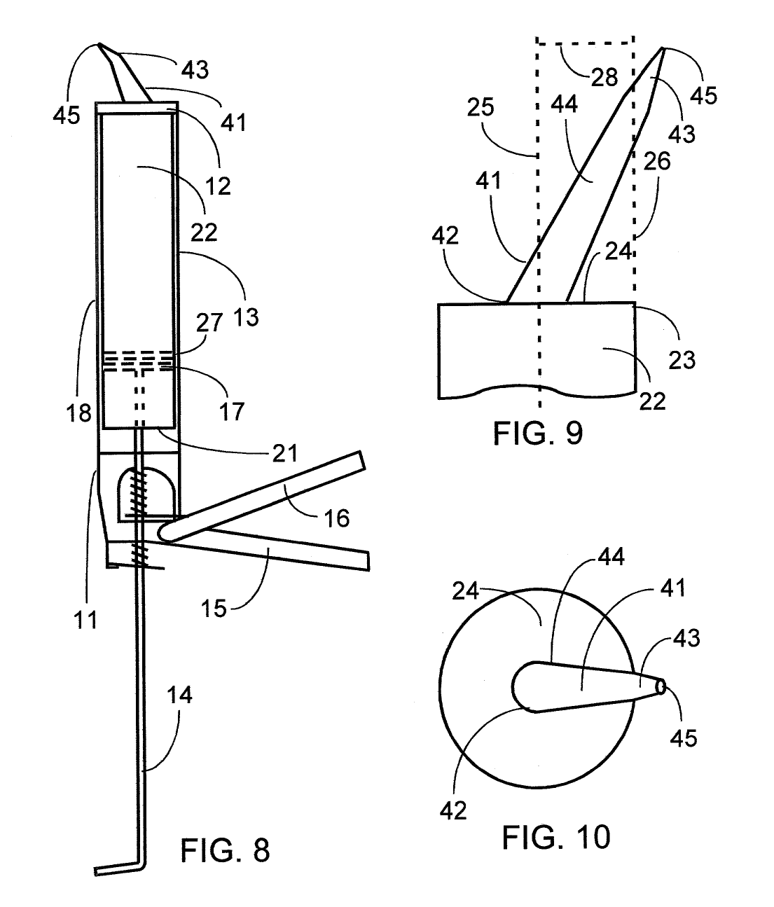

FIGS. 6 and 7 are views towards the cartridge fixed end wall 24 of the basic slanted offset nozzle 41 mounted in a caulking gun 11. The cylindrical shape of the caulking gun end piece 12 and the cartridge 21 allow the cartridge fixed end wall 24 and the slanted offset nozzle tubular mid section 44 to be rotated in a full circle. This in turn allows the slanted offset nozzle tip 33 and dispensing orifice 35 to be rotated in a full circle. In FIG. 6 the slanted offset nozzle 41 is mounted in the caulking gun 11 so that the slanted offset nozzle tip 43 and dispensing orifice 45 are offset towards the top of the caulking gun 18. In FIG. 7 the slanted offset nozzle 41 is rotated in the caulking gun 11 so that the slanted offset nozzle tip 43 and dispensing orifice 45 are offset towards one side of the caulking gun 11. FIG. 8 is a side view of a caulking cartridge 21 with a basic slanted offset nozzle 41 mounted in a caulking gun 11. The slanted offset nozzle 41 is mounted in the caulking gun 11 so that the slanted offset nozzle tip 43 and dispensing orifice 45 are offset away from the caulking gun lever 16 towards the top of the caulking gun 18.

The lateral offset of the slanted offset nozzle tip 43 and the slanted offset dispensing orifice 45 allow the dispensing orifice 45 to be located against surfaces that can not be reached with a caulking cartridge with a prior art nozzle 31. This allows caulking to be applied with a disposable caulking cartridge in locations that would require a curved or flexible nozzle attachment with a prior art nozzle 31. The caulking gun can be held and operated with one hand. The other hand is not needed to hold the slanted offset nozzle tip 43 in place. Rotation of the slanted offset nozzle 41 in the caulking gun 11 allows a user to rotate the caulking gun around the cartridge body longitudinal centerline 25. This in turn allows the user to hold his or her hand and body in the most comfortable position possible. This reduces user stress and can help users avoid dangerous positions.

In an alternative of the first embodiment of the present invention, the slanted offset dispensing orifice 45 of the slanted offset nozzle tip 43 is outside of the cartridge body cylindrical outer surface line 26. This alternative to the slanted offset nozzle will hereafter be referred to as the extended slanted offset nozzle. The extended slanted offset nozzle is similar to the basic slanted offset nozzle except the length of the slanted offset nozzle tubular mid section 44 is long enough so that the slanted offset nozzle tip 43 and slanted offset dispensing orifice 45 extend outside the cartridge body cylindrical outer surface line 26. FIGS. 9 and 10 show the extended slanted offset nozzle of the present invention. FIG. 4 is a side view of the basic slanted offset nozzle 41. FIG. 9 is a view towards the cartridge fixed end wall 24. The slanted offset nozzle base 42, which is attached to the cartridge fixed end wall 24, is symmetrical around the cartridge body centerline 25. The cartridge body section 22 is of the same configuration as the in the prior art. The cartridge cylindrical body section 22 has a cartridge body longitudinal centerline 25 and a cartridge body longitudinal outer surface line 26. The longitudinal outer surface line 26 continues past the fixed end wall 24 of the cartridge body to the tip of the slanted offset nozzle tip 43. The slanted offset nozzle tubular mid section 44 extends from the slanted offset nozzle base 42 to the slanted offset nozzle tip 43. The slanted offset nozzle tubular mid section 44 diverges at an angle away from the cartridge body longitudinal centerline 25 at the slanted offset nozzle base 42 past the cartridge body longitudinal outer surface line 26 at the slanted offset nozzle tip 43. The slanted offset nozzle tip 43 and the slanted offset dispensing orifice 45 are offset laterally from the cartridge body longitudinal centerline 25 outside the cartridge body cylindrical outer surface line 26.

The extended slanted offset nozzle configuration has certain advantages over the basic slanted offset nozzle configuration. The dispensing orifice of the extended slanted offset nozzle may allow caulking to be applied in certain very difficult to access locations that the basic slanted offset nozzle can not reach. Standard caulking cartridges roll sideways when placed on a sloped surface. Care must be taken with spare standard cartridges when placing them on a roof or other sloped surface to ensure that they do not roll away. The tip of the extended slanted offset nozzle prevents the cartridge from rolling. This is helpful when placing spare cartridges on a sloped surface. Conversely the basic slanted offset nozzle has certain advantages over the extended slanted offset nozzle. The cross section area required for assembly, storage and shipping of the basic slanted offset nozzle is only as great as the diameter of the cartridge body cylindrical outer surface line 26. Additional cross section area may be required in assembly, storage and shipping to accommodate the extended slanted offset nozzle tip 43 which is outside the cartridge body cylindrical outer surface line 26.

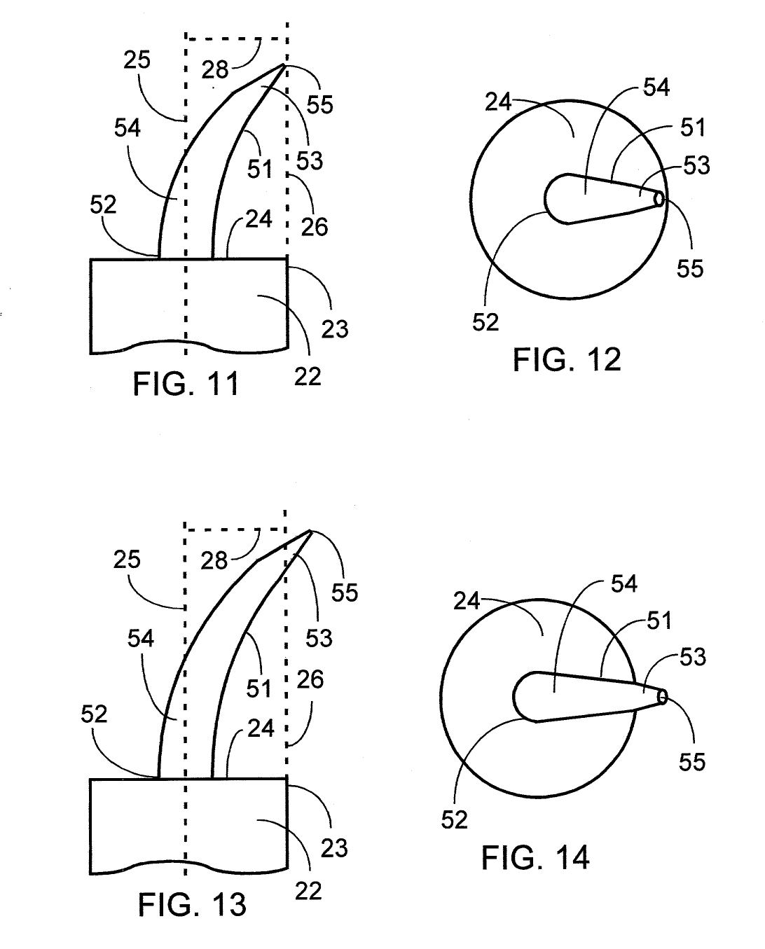

In the second embodiment of the present invention the nozzle tubular mid section is curved. This embodiment is thereafter referred to as the curved offset nozzle 51. FIGS. 11 and 12 show the basic configuration of the curved nozzle of the present invention hereafter referred to as the basic curved offset nozzle 51. FIG. 11 is a side view of the basic curved offset nozzle 51. FIG. 12 is a view towards the cartridge fixed end wall 24. The curved offset nozzle base 52, which is attached to the cartridge fixed end wall 24, is symmetrical around the cartridge body centerline 25. The cylindrical cartridge body section 22 is of the same configuration as the in the first embodiment of the present invention.

The curved offset nozzle tubular mid section 54 extends from the curved offset nozzle base 52 to the curved offset nozzle tip 53. The curved offset nozzle tubular mid section 54 curves away from the cartridge body longitudinal centerline 25 at the curved offset nozzle base 52 towards the cartridge body longitudinal outer surface line 26 at the curved offset nozzle tip 53. The curved offset nozzle tip 53 and the curved offset dispensing orifice 55 are offset laterally from the cartridge body longitudinal centerline 25 towards the cartridge body cylindrical outer surface line 26. In the basic configuration of the second embodiment of the present invention, the curved offset dispensing orifice 55 of the curved offset nozzle tip 53 is on, or within, the cartridge body cylindrical outer surface line 26.

The curved offset nozzle 51 has certain advantages over the slanted offset nozzle 41. The curved offset nozzle base 52 is perpendicular to the cartridge fixed end wall 24. The curved offset nozzle 51 eliminates the angle of the slanted offset nozzle 41 where the slanted offset nozzle base 42 is attached to the cartridge fixed end wall 24. This may facilitate application of particularly viscous materials. The curved offset nozzle 51 may allow caulking to be applied to certain very difficult to access locations that even the slanted offset nozzle 41 can not access. Conversely, the slanted offset nozzle 41 has certain advantages over the curved offset nozzle 51. The slanted offset nozzles 41 can be nested inside each other end to end prior to being attached to the cartridge. This may facilitate cartridge assembly operations. The curved offset nozzles can not be nested inside each other as well. This may complicate cartridge assembly operations.

An alternative of the second embodiment is the extended curved offset nozzle. The extended alternative of the curved offset nozzle is similar to the basic curved offset nozzle except the length of the curved offset nozzle tubular mid section 54 is long enough so that the curved offset nozzle tip 53 and curved offset dispensing orifice 55 extend outside the cartridge body cylindrical outer surface line 26. FIGS. 13 and 14 show the extended configuration of the second embodiment of the caulking cartridge nozzle of the present invention. FIG. 13 is a side view of the extended curved offset nozzle. FIG. 14 is a view towards the cartridge fixed end wall 24. The curved offset nozzle base 52, which is attached to the cartridge fixed end wall 24, is symmetrical around the cartridge body centerline 25. The cylindrical cartridge body section 22 is of the same configuration as the in the prior art. The cartridge cylindrical body section 22 has a cartridge body longitudinal centerline 25 and a cartridge body longitudinal outer surface line 26. The longitudinal outer surface line 26 continues past the fixed end wall 24 of the cartridge body to the tip of the curved offset nozzle tip 53. The curved offset nozzle tubular mid section 54 extends from the curved offset nozzle base 52 to the curved offset nozzle tip 53. The curved offset nozzle tubular mid section 54 curves away from the cartridge body longitudinal centerline 25 at the curved offset nozzle base 52 past the cartridge body longitudinal outer surface line 26 at the curved offset nozzle tip 53. The curved offset nozzle tip 53 and the curved offset dispensing orifice 55 are offset laterally from the cartridge body longitudinal centerline 25 past the cartridge body cylindrical outer surface line 26. In the extended configuration of the second embodiment of the present invention, the curved offset dispensing orifice 55 of the curved offset nozzle tip 53 is outside of the cartridge body cylindrical outer surface line 26.

The advantages and disadvantages between the basic curved offset nozzle and the extended curved offset nozzle configurations are similar to the advantages and disadvantages between the basic slanted offset nozzle and the extended slanted offset nozzle configurations. The dispensing orifice of the extended curved offset nozzle may allow caulking to be applied in certain very difficult to access locations that the basic curved offset nozzle can not reach. The tip of the extended curved offset nozzle prevents the cartridge from rolling on sloped surfaces. Additional cross section area may be required in assembly, storage and shipping to accommodate the extended curved offset nozzle tip.

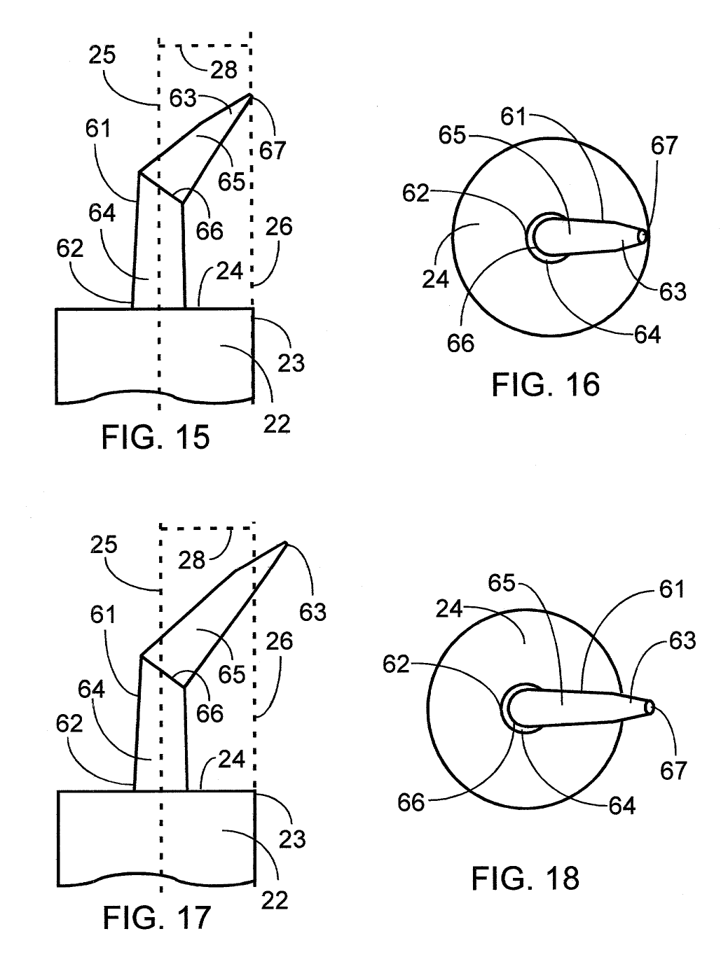

In the third embodiment of the present invention the tubular section of the nozzle is comprised of two straight tubular sections connected by a rigid joint. This embodiment is thereafter referred to as the jointed offset nozzle 61. FIGS. 15 and 16 show the basic configuration of the jointed offset nozzle of the present invention hereafter referred to as the basic jointed offset nozzle 61. FIG. 15 is a side view of the basic jointed offset nozzle 61. FIG. 16 is a view towards the cartridge fixed end wall 24 of the basic jointed offset nozzle. The cartridge body section 22 is of the same configuration as in the prior art. The cartridge cylindrical body section 22 has a cartridge body longitudinal centerline 25 and a cartridge body longitudinal outer surface line 26. The longitudinal outer surface line 26 continues past the fixed end wall 24 of the cartridge body to the tip of the jointed offset nozzle tip 63. The jointed offset nozzle base 62, which is attached to the cartridge fixed end wall 24, is symmetrical around the cartridge body centerline 25. The jointed offset nozzle tubular section is comprised of a tubular near section 64, a tubular far section 65 and a joint between the tubular near section and the tubular section 66. The tubular near section 64 extends from the curved offset nozzle base 62 to the joint between the near and far tubular sections 66. The tubular near section 64 is symmetrical around the cartridge body longitudinal centerline 25. The tubular far section 65 extends from the joint between the near and far tubular sections 66 to the jointed offset nozzle tip 63. The tubular far section 64 diverges at an angle away from the cartridge body longitudinal centerline 25 at the joint between the near and far tubular sections 66 towards the cartridge body longitudinal outer surface line 26 at the jointed offset nozzle tip 63. The jointed offset nozzle tip 63 and the jointed offset dispensing orifice 67 are offset laterally from the cartridge body longitudinal centerline 25 towards the cartridge body cylindrical outer surface line 26. In the basic configuration of the third embodiment of the present invention, the jointed offset dispensing orifice 67 of the jointed offset nozzle tip 63 is on, or within, the cartridge body cylindrical outer surface line 26.

The jointed offset nozzle 61 has certain advantages over the slanted offset nozzle 41 and the curved offset nozzle 51. The jointed offset nozzle 61 may allow caulking to be applied to certain very difficult to access locations that even the slanted offset nozzle 41 or the curved offset nozzle 51 can not access. Conversely, the slanted offset nozzle 41 and the curved offset nozzle 51 have certain advantages over the jointed offset nozzle 61. The slanted offset nozzles 41 can be nested inside each other end to end prior to being attached to the cartridge. This may facilitate cartridge assembly operations. The jointed offset nozzles 61 can not be nested inside each other as well. This may complicate cartridge assembly operations. The curved offset nozzle 51 eliminates the angle of the jointed offset nozzle 41 where the slanted offset nozzle near tubular section 64 is attached to the slanted offset nozzle far tubular section 65. This may facilitate application of particularly viscous materials.

FIGS. 17 and 18 show the extended configuration of the third embodiment of the caulking cartridge nozzle of the present invention hereafter referred to as the extended jointed offset nozzle 61. FIG. 17 is a side view of the extended jointed offset nozzle 61. FIG. 18 is a view towards the cartridge fixed end wall 24 of the extended jointed offset nozzle 61. The jointed offset nozzle base 62, which is attached to the cartridge fixed end wall 24, is symmetrical around the cartridge body centerline 25. The cylindrical cartridge body section 22 is of the same configuration as the in the prior art. The cartridge cylindrical body section 22 has a cartridge body longitudinal centerline 25 and a cartridge body longitudinal outer surface line 26. The longitudinal outer surface line 26 continues past the fixed end wall 24 of the cartridge body to the tip of the jointed offset nozzle tip 63. The tubular near section 64 extends from the curved offset nozzle base 62 to the joint between the near and distant tubular sections 66. The tubular near section 64 is symmetrical around the cartridge body longitudinal centerline 25. The tubular far section 65 extends from the joint between the near and distant tubular sections 66 to the jointed offset nozzle tip 63. The tubular far section 64 angles away from the cartridge body longitudinal centerline 25 at the joint between the near and distant tubular sections 66 past the cartridge body longitudinal outer surface line 26 at the jointed offset nozzle tip 63. The jointed offset nozzle tip 63 and the jointed offset dispensing orifice 67 are offset laterally from the cartridge body longitudinal centerline 25 past the cartridge body cylindrical outer surface line 26. In the extended configuration of the third embodiment of the present invention, the jointed offset dispensing orifice 67 of the jointed offset nozzle tip 63 is outside of the cartridge body cylindrical outer surface line 26.

The advantages and disadvantages between the basic jointed offset nozzle and the extended jointed offset nozzle configurations are similar to the advantages and disadvantages between the basic slanted offset nozzle and the extended slanted offset nozzle configurations. The dispensing orifice of the extended jointed offset nozzle may allow caulking to be applied in certain very difficult to access locations that the basic jointed offset nozzle can not reach. The tip of the extended jointed offset nozzle prevents the cartridge from rolling on sloped surfaces. Additional cross section area may be required in assembly, storage and shipping to accommodate the extended jointed offset nozzle tip.

I claim:

1. A disposable cartridge for holding and dispensing material comprising:
a cylindrical body section for holding said material,
a rigid slanted nozzle for dispensing the material, and
a moveable diaphragm for propelling the material in the cylindrical body section towards said rigid slanted nozzle,
said body cylindrical body section comprising:
a cylindrical side wall,
an end wall rigidly attached to one end of said cylindrical side wall,
a body section longitudinal centerline,
a body section longitudinal outer surface line, and
a cartridge body radius extending from the cartridge body longitudinal centerline to the cartridge body cylindrical outer surface line,
said cartridge body radius is of constant length along the entire length of the cylindrical body section and the rigid slanted nozzle, and
the slanted dispensing nozzle comprising:
a nozzle base whereby the dispensing nozzle is attached to the cylindrical body section end wall,
a nozzle tip for directing the location where the material is dispensed, and
a straight nozzle tubular section for conveying the material from the cartridge body section to said nozzle tip,
said nozzle base being symmetrical around said body section longitudinal centerline,
the nozzle tip being laterally offset from the body section longitudinal centerline towards the section longitudinal outer surface line,
said straight nozzle tubular section diverges at an angle away from said nozzle base symmetrical around the body section longitudinal centerline towards the nozzle tip which is offset from the body section longitudinal centerline towards the body section longitudinal outer surface line,
the nozzle being comprised of material which is capable of being cut whereby the nozzle tip may be cut or severed by a knife or other sharp device to produce a dispensing orifice at the end of the tip, and
the nozzle tip being tapered whereby the diameter of said dispensing orifice may be controlled by the location where the tip is severed.

2. The slanted nozzle of claim 1 wherein the nozzle tip and dispensing orifice are within the longitudinal outer surface line of the cylindrical body section.

3. The slanted nozzle of claim 1 wherein the nozzle tip and dispensing orifice are outside the longitudinal outer surface line of the cylindrical body section.

2. A disposable cartridge for holding and dispensing material comprising:
a cylindrical body section for holding said material,
a rigid curved nozzle for dispensing the material, and
a moveable diaphragm for propelling the material in the cylindrical body section towards said curved nozzle,
said body cylindrical body section comprising:
a cylindrical side wall,
an end wall rigidly attached to one end of said cylindrical side wall,
a body section longitudinal centerline,
a body section longitudinal outer surface line, and
a cartridge body radius extending from the cartridge body longitudinal centerline to the cartridge body cylindrical outer surface line,
said cartridge body radius is of constant length along the entire length of the cylindrical body section and the rigid curved nozzle, and
the curved dispensing nozzle comprising:
a nozzle base whereby the dispensing nozzle is attached to the cylindrical body section end wall,
a nozzle tip for directing the location where the material is dispensed, and
a curved nozzle tubular section for conveying the material from the cartridge body section to said nozzle tip,
said nozzle base being symmetrical around said body section longitudinal centerline,
the nozzle tip being laterally offset from the body section longitudinal centerline towards the section longitudinal outer surface line,
said curved nozzle tubular section being curved from said nozzle base symmetrical around the body section longitudinal centerline towards the nozzle tip which is offset from the body section longitudinal centerline towards the body section longitudinal outer surface line,
the curved nozzle being comprised of material which is capable of being cut whereby the nozzle tip may be cut or severed by a knife or other sharp device to produce a dispensing orifice at the end of the tip, and
the nozzle tip being tapered whereby the diameter of said dispensing orifice may be controlled by the location where the tip is severed.

8. The curved nozzle of claim 4 wherein the nozzle tip and dispensing orifice are within the longitudinal outer surface line of the cylindrical body section.

9. The curved nozzle of claim 4 wherein the nozzle tip and dispensing orifice are outside the longitudinal outer surface line of the cylindrical body section.

8. A disposable cartridge for holding and dispensing material comprising:
a cylindrical body section for holding said material,
a rigid jointed nozzle for dispensing the material, and
a moveable diaphragm for propelling the material in the cylindrical body section towards said jointed nozzle,
said body cylindrical body section comprising:
a cylindrical side wall,
an end wall rigidly attached to one end of said cylindrical side wall,
a body section longitudinal centerline,
a body section longitudinal outer surface line, and
a cartridge body radius extending from the cartridge body longitudinal centerline to the cartridge body cylindrical outer surface line,
said cartridge body radius is of constant length along the entire length of the cylindrical body section and the rigid jointed nozzle, and
the jointed nozzle comprising:
a nozzle base whereby the dispensing nozzle is attached to the cylindrical body section end wall,
a nozzle tip for directing the location where the material is dispensed, and
a jointed nozzle tube for conveying the material from the cartridge body section to said nozzle tip,
said nozzle base being symmetrical around said body section longitudinal centerline,
the nozzle tip being laterally offset from the body section longitudinal centerline towards the section longitudinal outer surface line,
said jointed nozzle tube comprised of a near tubular section and a far tubular section, said near tubular section extending from the nozzle base to the far tubular section,
said far tubular section extending from the near tubular section to the nozzle tip, the near tubular section and the far tubular section being connected by a rigid joint,
the near tubular section being symmetrical around the body section longitudinal centerline,
the far tubular section being diverges at an angle away from the body section longitudinal centerline towards the nozzle tip which is offset from the body section longitudinal centerline towards the body
section longitudinal outer surface line,
the jointed nozzle being comprised of material which is capable of being cut whereby the nozzle tip may be cut or severed by a knife or other sharp device to produce a dispensing orifice at the end of the tip, and
the nozzle tip being tapered whereby the diameter of said dispensing orifice may be controlled by the location where the tip is severed.

8. The jointed nozzle of claim 7 wherein the nozzle tip and dispensing orifice are within the longitudinal outer surface line of the cylindrical body section.

9. The jointed nozzle of claim 7 wherein the nozzle tip and dispensing orifice are outside the longitudinal outer surface line of the cylindrical body section.
